(19) United States
(12) Patent Application Publication
(10) Pub. No.: US 2002/0143974 A1
(43) Pub. Date: Oct. 3, 2002

(54) Local account manager for a media delivery network

(76) Inventors: Scott Swix, Duluth, GA (US); P. Thomas Watson, Alpharetta, GA (US); Randy S. Zimler, Gainesville, GA (US); James Gray, Atlanta, GA (US); Timothy H. Weaver, Alpharetta, GA (US)

Correspondence Address: MERCHANT & GOULD PC, P.O. BOX 2903, MINNEAPOLIS, MN, 55402-0903, US

(21) Appl. No.: 09/893,332

(22) Filed: Jun. 27, 2001

Related U.S. Application Data
(60) Provisional application No. 60/281,205, filed on Apr. 2, 2001.

(51) Int. Cl. G06F 15/16; G06F 17/30

(52) U.S. Cl. 709/231; 707/10

(57) ABSTRACT

A media delivery service provider has a customer account management center associated with it. The customer account management center has a customer account database for maintaining account information and billing information for all subscribers to the Media Delivery Service Provider. The customer account management center is operative to communicate with a local account manager in a Media Distribution Device (MDD) over a broadband connection. Because a broadband connection can maintain an always-on status, the local account manager can autonomously send local account data to the customer account management center during off-peak hours of operation, thereby reducing the impact on system resources. Any changes made by the customer to a local account data can be immediately effective to modify the media delivered to the MDD. The local account data can be later packaged and transmitted by the local manager to the customer account management center.

### FIELD OF THE INVENTION

The present invention generally relates to a media delivery service system. More particularly, the present invention relates to enabling localized customer account management within a media delivery service system.

### BACKGROUND OF INVENTION

More than ever before, residential consumers are being provided with a wealth of media resources. While cable television, the Internet, and on-demand media have been available for years, recently developed high-speed broadband technologies are enhancing the delivery of these media services. These technologies have made it possible to increase the variety of available media services and to enhance the ability of the user to interact with the media delivery system to tailor media delivery to the user's preferences. Satellite communications, asymmetric digital subscriber lines (ADSL), and broadband cable are providing new high-throughput connections to media delivery services. Media services consumers are commonly establishing wireless connections to satellites, telephony-based connections to ADSL, and broadband cable connections to the media service providers. Typically, these connections are processed by a Media Distribution Device (MDD) that processes media content and data and routes the media and/or data to media presentation devices, such as a television or personal computer. A conventional Set-Top Box is an example of a MDD.

It has become commonplace for media delivery service providers to provide an access point through which a customer can tailor the customer's account to the customer's preference. For example, such an access point might permit the customer to choose between various predefined media delivery packages. The access point also may be used to enable the customer to create its own media package by picking and choosing from available media content. The access point also may permit a customer to select media content on a “pay-per-view” basis.

A customer account access point can also be used to provide the customer with various billing options. For example, the user may be able to view a current bill, verify the bill's accuracy, and pay the current bill through a predefined debit process. The customer account access point may also allow the customer to determine the effects of an account modification on future bills by generating a simulated bill reflecting the additional media delivery services requested.

Various approaches have been implemented to provide such customer account access points. The first such approach permitted a customer to contact an operator by telephone. The customer could request that the operator provide account information and/or make modifications to the customer's account. The operator would check a customer account database to verify the caller's identity and, if authorized, would provide the requested information or modify the customer's account. Alternatively, the operator might provide an authorization number that the customer could enter into a MDD, such as a conventional Set-Top Box to modify the media services provided to the MDD.

Another approach for providing a customer account access point implemented an automated system such as a telephony-based Interactive Voice Response (IVR) system that automated the access and authorization functionality. Yet another approach was developed following the advent of two-way communication between the media delivery service provider and the MDD (e.g. an ADSL communication link). In this approach, the MDD would have a built-in user interface that would permit the customer to access a centralized customer account database. Once the customer had obtained access to the centralized customer account database, the customer could obtain account information and/or modify the customer's account.

Unfortunately, all of these approaches suffer from the same shortcoming. All of these approaches require that a centralized customer database be continuously updated and accessible. This maintenance and accessibility can be expensive, because comprehensive records must be kept and updated for every customer of the media delivery service provider. In addition, communication between the customer's MDD and the centralized customer database is demanding of network resources. Providing customers with continuous access under the approaches listed above can congest communication between the media delivery service provider and all other customers on the network.

Therefore, there is a need in the art for a localized account management tool that enables a customer to modify an account locally, without requiring real-time interaction with a centralized customer account database. The account modifications made with the localized account management tool should be instantaneously effective. The localized account management tool also should provide access to updated customer billing records.

### SUMMARY OF THE INVENTION

A media delivery service provider has a customer account management center associated with it. The customer account management center has a customer account database for maintaining account information and billing information for all subscribers to the Media Delivery Service Provider. The customer account management center is operative to communicate with a local account manager in a Media Distribution Device (MDD) over a broadband connection. Because a broadband connection can maintain an always-on status, the local account manager can autonomously send local account data to the customer account management center during off-peak hours of operation, thereby reducing the impact on system resources. Any changes made by the customer to local account data can be immediately effective to modify the media delivered to the MDD. The local account data can be later packaged and transmitted by the local manager to the customer account management center.

The customer account management center can examine the received local account data and update the customer account database to reflect the customer's desired account modifications. The transmission of local account data to the customer account management center can be done during off-peak hours or at any time. The customer account management center can query the MDD to initiate such a transmission at any time. The high-speed communication provided by an ADSL connection enables real-time modification of the customer account database, should such a modification be desired. Moreover, a broadband connection between the MDD and the media delivery service provider enables the transmission of very large amount of media content. As described above, the local account manager can be used to filter the media content on a per-customer basis. Thus, a customer can receive instantaneous delivery of media content, without requiring interaction with the customer account management center.

The various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a block diagram of an exemplary operating environment in which embodiments of the present invention may be implemented.

FIG. 2 is a block diagram depicting some of the primary components of an exemplary Media Distribution Device.

FIG. 3 is a block diagram depicting a Media Delivery Account Management System that is an exemplary embodiment of the present invention.

FIG. 4 is a flow chart depicting an exemplary method for locally modifying a media delivery services account.

### DETAILED DESCRIPTION

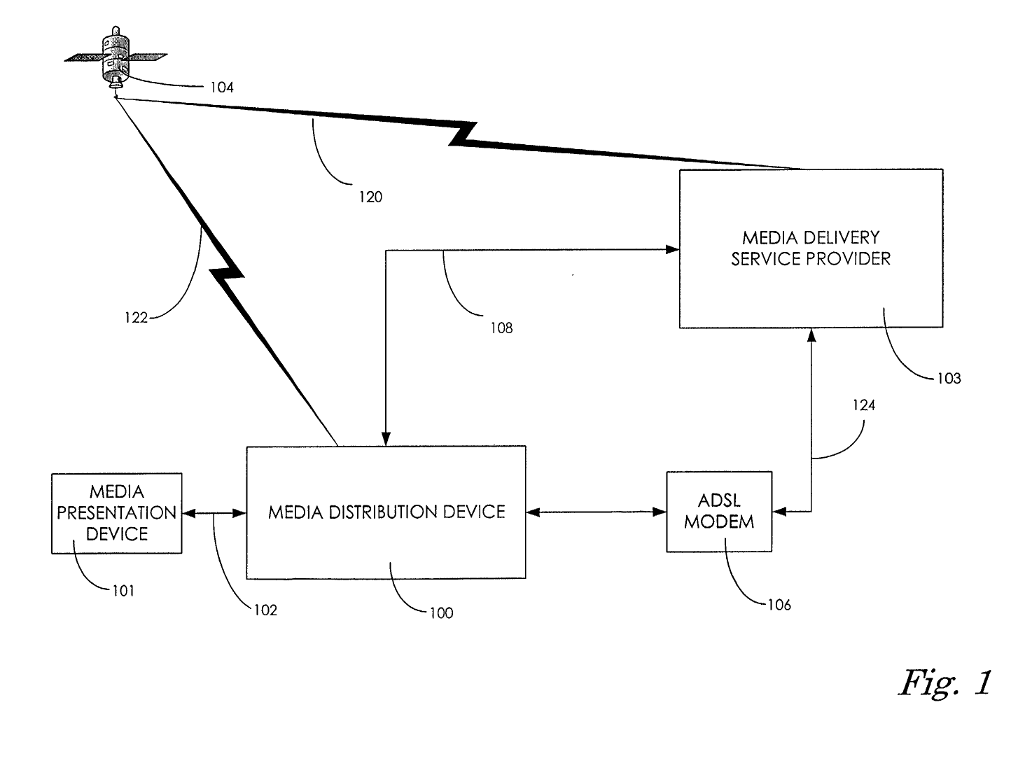

FIG. 1 is a block diagram of an exemplary operating environment in which embodiments of the present invention may be implemented. Media is typically delivered to a customer by means of a Media Distribution Device 100. The most common Media Distribution Devices are conventional Set-Top Boxes (STBs). The Media Distribution Device (MDD) 100 can provide media content and/or data to a media presentation device 101 over communication link 102. The most common example of a media presentation device 101 is a conventional television. Typically, the MDD 100 will deliver only media content to media presentation device 101. However, more recently developed media presentation devices 101 also have the ability to process data received from the MDD 100. Such data may include information pertaining to the presentation of the media content on the media presentation device 101.

Another example of a media presentation device 101 is a conventional personal computer. The personal computer can receive media content, such as Internet content from the Media Distribution Device and present it to a customer/user. As is well known, a personal computer can also process data received from the Media Distribution Device 100 to format the presentation of the delivered media content.

The MDD 100 can receive media content and data from one or more sources. In the example of FIG. 1, the MDD 100 is depicted receiving media and data from a media delivery service provider 103. Examples of media delivery service providers 103 include a cable T.V. provider, a satellite T.V. provider, an Internet service provider, and a telephone service provider. Notably, the media content and data may be delivered over a single communication link or may be delivered over separate communication links.

In the example of FIG. 1, the media delivery service provider 103 can provide media content and data to the MDD 100 via an Asymmetric Digital Subscriber Line (ADSL) modem 106. The media delivery service provider 103 may also provide media content and data to the MDD 100 via a satellite 104. The satellite can deliver media content and data directly to the MDD 100 over communications link 122. Such a direct link usually involves the use of a small satellite dish in conjunction with the MDD 100. The satellite 104 can also deliver the media content and data to the media delivery service provider 103 via communication link 120 from, for example, another media distribution service. This media content and data may be rerouted to the MDD 100 from the media delivery service provider 103 over a separate communication link.

The MDD 100 may also have a direct communication link 108 with the media delivery service provider 103. Such a link might be a conventional 2400 baud modem connection to the media delivery service provider 103. This communication link 108 may also be a direct hardwire connection or a network connection, such as an Ethernet connection.

In any event, the MDD 100 receives media content and data from a media delivery service provider 103 and delivers the media content and/or data to the media presentation device 101 for presentation to the customer. Typically, the MDD 100 can communicate in two-directions over communication links 108 and 124. That is, the MDD 100 can respond to queries and/or commands received from the media delivery service provider and return data and/or messages, in response to the receipt of a query or command. The Simple Network Management Protocol (SNMP) is a standard that has been developed to standardize such two-way communication between the MDD 100 and the media delivery service provider 103. Typically, an SNMP agent will be installed in the MDD 100 and will coordinate all SNMP communications between the MDD 100 and the media delivery service provider 103. Notably, such two-way communications are not typically available over communications link 122 with the satellite 104.

When a customer associated with the media presentation device 101 wishes to modify his media delivery customer account or wishes to obtain billing information, the customer will typically contact the media delivery service provider 103 by telephone, via a website, or by means of a user interface integrated into the media presentation device 101 and/or the MDD 100. The conventional media delivery system requires two-way communication between the MDD 100 and the media delivery service provider 103. The customer can access and modify the customer's account in real-time. Thereafter, the media delivery service provider 103 will modify the media delivery to the customer, in accordance with the customer's account modification. For example, the media delivery service provider may configure the signal to the customer's MDD 100 to exclude (i.e., disable presentation of) a cable T.V. channel that the customer was previously receiving. The media delivery service provider 103 will modify a customer account database to reflect the changes made by the customer.

In an exemplary embodiment of the present invention, the customer can modify its customer account locally, without initiating two-way communication with the media delivery service provider 103. While the media delivery service provider 103 can still maintain a customer account database, the customer account modifications need not be immediately transmitted to the media delivery service provider. Subsequently, preferably at an off-peak time, the customer's modifications to its customer account can be transmitted to the media delivery service provider 103 for modification of the customer account database. Thus, the media delivery service provider's network is not burdened by customer account transactions during peak hours of operation.

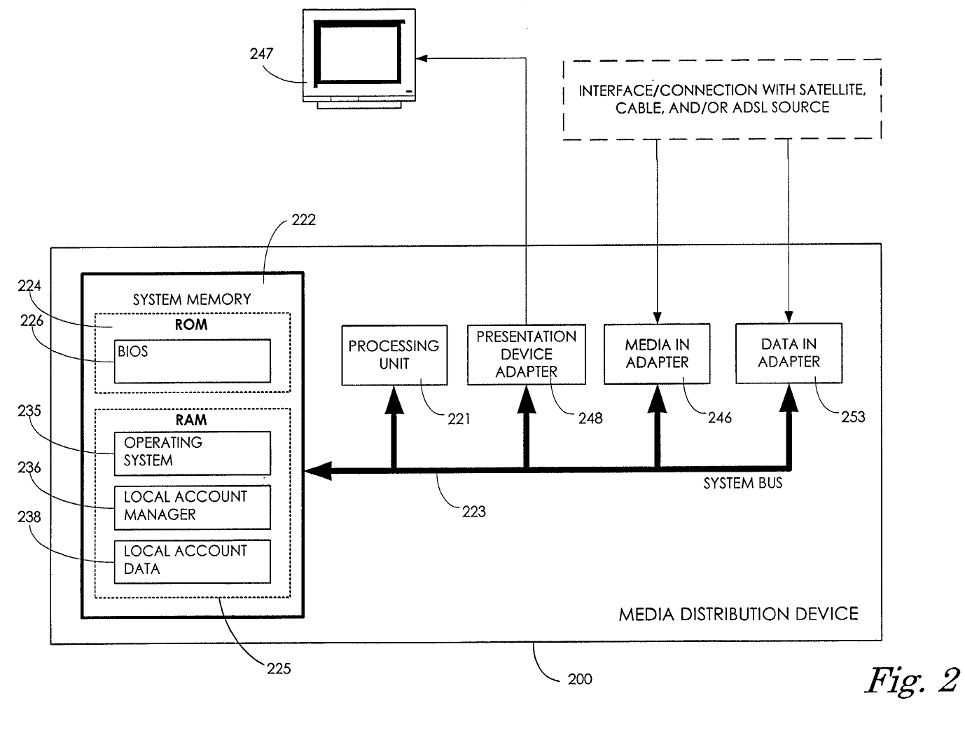

FIG. 2 is a block diagram depicting some of the primary components of an exemplary Media Distribution Device. The conventional Media Distribution Device 200 includes a processing unit 221, a system memory 222, and a system bus 223 that couples the system memory to the processing unit. The system memory 222 includes read-only memory (ROM) 224 and random access memory (RAM) 225. A basic input/output system 226 (BIOS) contains rudimentary code to execute basic functions, such as system start-up. The BIOS 226 is stored in the ROM 224. Various other program modules may be stored in the RAM 225. Such program modules might include an operating system 235, a local account manager 236 and local account data module 238.

Although not depicted in FIG. 2, the MDD 200 could also include a hard drive or other non-volatile memory for long-term storage of program modules such as the operating system 235, the local account manager 236, and the local account data module 238. The hard drive may be connected to the MDD via a hard drive interface (not shown). Similarly, other peripheral devices could be connected to the MDD with other interfaces not depicted in FIG. 2. The MDD also could be equipped with an input device, such as a keyboard and/or mouse.

The MDD 200 also can include a video adapter 248 or other adapter for delivery of media content and/or data to a media presentation device 247. The MDD 200 also can include a Media In Adapter 246 and a Data In Adapter 253. These adapters permit connection of the MDD 200 to a communication link for one-way and/or two-way communication with a media delivery service provider. The Media In Adapter 246 and the Data In Adapter 253 may incorporate a modem and/or other communication device.

The MDD 200 can receive media content and data and makes the media content and data available to other components by way of the system bus 223. The processing unit 221 can route the media content and/or data in accordance with the instructions of the operating system 235 and/or other applications executed in the RAM 225. In addition, the processing unit 221 may store the media content and data in the RAM 225 for subsequent use. The processing unit 221 may also direct the media content and/or data to the media presentation device 247 via the presentation device adapter 248.

The local account manager 236 may be executed by the processing unit 221, in response to a command received from the customer. Such a command might be initiated by use of an input device. Once the local account manager 236 has been executed, the local account manager may access the local account data module 238 to obtain the customer's current account information and/or current billing information. The local account manager 236 may present the requested information to the customer, for example, in a graphical user interface displayed on the media presentation device 247. The user may modify the customer account information through an input device connected to the MDD 200 and/or the media presentation device 247. When the customer is finished making modifications to the customer account, the modified customer account data can be stored in the RAM 225 and in non-volatile memory, such as a hard drive (not shown). The local account data module may also be time-stamped to indicate the last time that data was modified.

During off-peak hours, the local account manager 236 may autonomously check the local account data module 238 to determine whether the local account data has been modified since the last update to the centralized customer account database associated with the media delivery service provider. If a more recent modification has been made by the customer, the local account manager can package the local account data module 238 and transmit that data to the media delivery service provider. The media delivery service provider can then update the customer account database to reflect the modifications.

Advantageously, the local account manager 236 can instantaneously implement the customer's account modifications. The local account manager 236 is operative to decode the media delivered from the media delivery service provider in accordance with the customer's local account data module 238. For example, the media delivery service provider can send a full stream of media to the MDD 200, including media not included in the customer's account. The local account manager 236 acts as a filter to provide the customer with access to those forms of media (i.e., portions of the media stream) that are part of the customer's account and to block the customer's access to media that is not part of the customer's account. Thus, local modification of the local account manager 236 can immediately alter this behavior and, thereby, implement the customer's modifications without requiring access to or authorization from the media delivery service provider. The local account data module 238 and the customer's account information maintained in the centralized customer account database can be reconciled during off-peak hours.

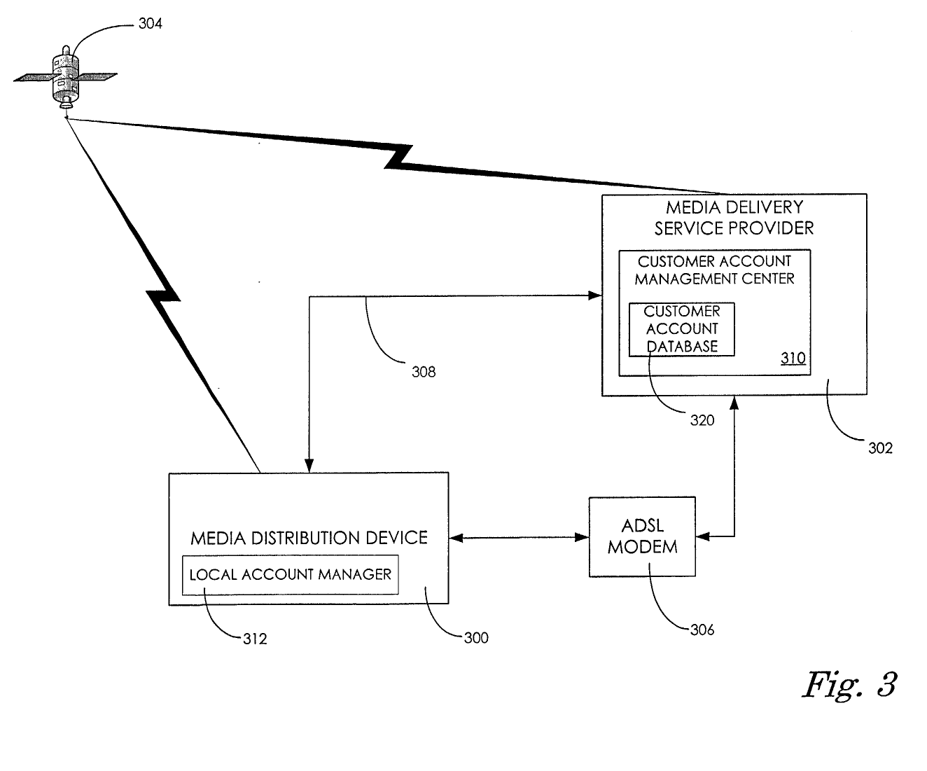

FIG. 3 is a block diagram depicting a media delivery account management system that is an exemplary embodiment of the present invention. The media delivery service provider 302 has a customer account management center 310 associated with it. The customer account management center 310 has a customer account database 320 for maintaining account information and billing information for all subscribers to the Media Delivery Service Provider 302. The customer account management center 310 is operative to communicate with the MDD 300 via the satellite 304, a direct link 308, and/or ADSL modem 306. A broadband connection between the media delivery service provider 302 and the MDD 300 is preferable, because it permits the customer account management center 310 to access the MDD 300 in real-time and can support an “always-on” connection. Because a broadband connection can maintain an always-on status, the local account manager 312 can autonomously send local account data to the customer account management center 310 during off-peak hours of operation, thereby reducing the impact on system resources.

Any changes made by the customer to the local account data can be packaged and transmitted by the local manager 312 to the customer account management center 310. The customer account management center can examine the received local account data and update the customer account database 320 to reflect the customer's desired account modifications. Although the preferable time for transmitting local account data to the customer account management center 310 has been described as being during off-peak hours, it will be appreciated that this transmission can take place at any time. Accordingly, the customer account management center can query the MDD 300 to initiate such a transmission at any time. The customer account management center 310 might be configured to identify low-traffic times and to autonomously initiate such a query. The always-on status of an ADSL connection between the MDD 300 and the media delivery service provider 302 supports such transmissions. Additionally, the high-speed communication provided by an ADSL connection enables real-time modification of the customer account database 320, should such a modification be desired. Moreover, a broadband connection between the MDD 300 and the media delivery service provider 302 enables the transmission of very large amount of media content. As described above, the local account manager 312 can be used to filter the media content on a per-customer basis. Thus, a customer can receive instantaneous delivery of media content, without requiring interaction with the customer account management center 310.

Although the broadband connection depicted in FIG. 3 is supported by means of an ADSL modem 306, virtually any broadband technology can be used to implement an exemplary embodiment of the present invention. For example, a conventional broadband cable-TV connection between the media delivery service provider 302 and the MDD 300 can be used. Unfortunately, current broadband cable-TV protocols are not as secure as an ADSL broadband communication link. Broadband cable-TV signals can be intercepted and deciphered, while the communication link between the ADSL modem 306 and the media delivery service provider 302 can be implemented as a Private Virtual Network that is not shared by other users. Thus, an ADSL broadband connection between the MDD 300 and the media delivery service provider 302 is preferred to other available broadband connections.

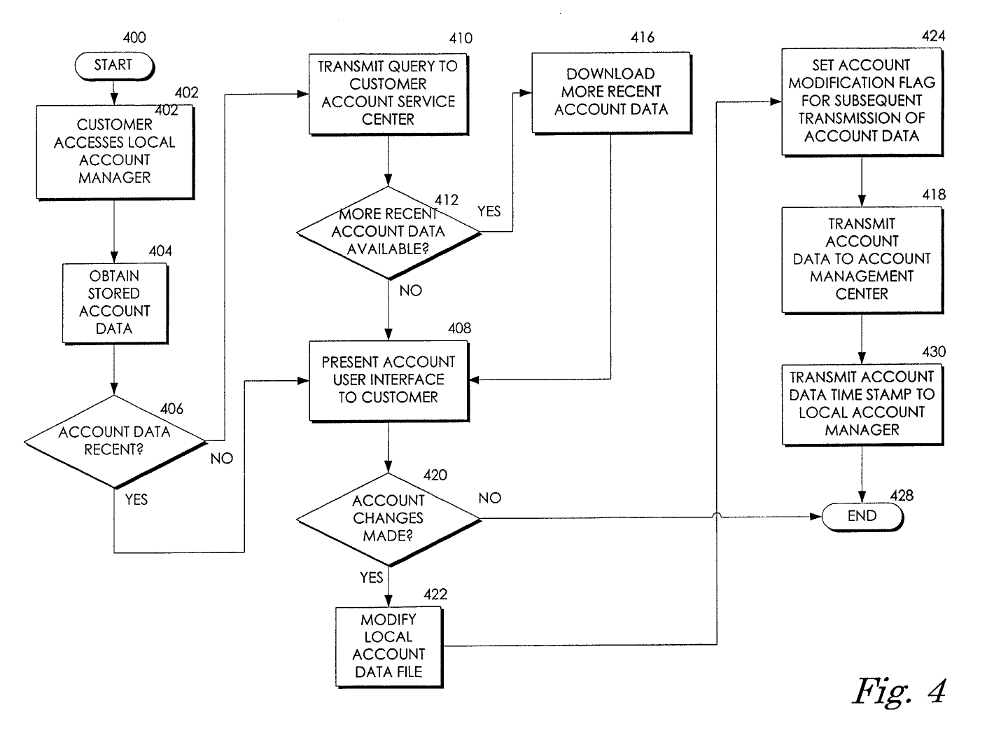

FIG. 4 is a flow chart depicting an exemplary method for locally modifying a media delivery services account. The method for FIG. 4 can be implemented to permit the local modification of a customer's account parameters that may be subsequently transmitted to a centralized customer account database. Those skilled in the art will appreciate that various modifications may be made to this embodiment within the scope of the present invention to incorporate various policies of the media delivery service provider. For example, security and privacy steps may be added to the method to ensure the protection of customer account data.

The method begins at step 400 and proceeds to step 402. At step 402, a customer accesses a local account manager. The customer may request access by selecting a function of an MDD (e.g., pressing a button), by sending a command from a media presentation device to the MDD, or by any other means. The method proceeds from step 402 to step 404. At step 404 the stored account data is obtained. In the example of FIG. 3, the local account manager may perform this step. The account data may be stored in the RAM in the MDD or in a non-volatile storage unit, such as a hard drive associated with the MDD.

The method proceeds from step 404 to decision block 406. At decision block 406, a determination is made as to whether the account data is recent. A threshold level can be predetermined to define an account data age that is recent. For example, the media delivery service provider may have a policy that disallows customer access to data that is older than one month. The account data can be stored in association with a time stamp to indicate the last modification and/or update to the account data.

If the account data is recent, the method branches from decision block 406 to step 408. At step 408, an account user interface is presented to the customer. This account user interface can be presented, for example, by displaying a graphical user interface on the media presentation device and providing controls by which the customer can access account data and/or modify account data. The method proceeds from step 408 to decision block 420.

At decision block 420, a determination is made as to whether any changes are made to the account data. If no changes are made, the method proceeds to step 428 and ends. If, on the other hand, account changes are made, the method branches from decision block 420 to step 422. At step 422, a local account data file can be modified to reflect the account changes made by the customer. For example, the customer may have decided to order the subsequent delivery of a pay-per-view event or may have added a broadcast channel to the customers existing media delivery services package. The method proceeds from step 422 to step 424. At step 424, an account modification flag is set to indicate the need to transmit he locally stored account data to the customer account management center. The method proceeds from step 424 to step 418. At step 418, the account data is transmitted to the account management center. Those skilled in the art will appreciate that step 418 may be performed at an off-peak hour to avoid taxing the media delivery service provider's network. The method proceeds from step 418 to step 430. At step 430 an account data time stamp is transmitted from the customer account management center to the local account manager. This time stamp can be associated with the account data to indicate that it has been approved and to indicate the time of approval. The method then proceeds to step 428 and ends.

Returning now to step 406, if a determination is made that the account data is not recent, the method will branch to step 410. At step 410, a query is transmitted to the customer account service center to obtain more recent account data. The message proceeds from step 410 to decision block 412. At decision block 412, a determination is made as to whether the customer account service center contains more recent account data related to the customer. If the customer account service center has more recent data, the method branches to step 416. At step 416, the more recent account data is downloaded to the MDD. The method then proceeds to step 408 and the account user interface is presented to the customer.

Returning to decision block 412, if a determination is made that no more recent account data is available in the customer account service center, the method branches from decision block 412 to step 408. At step 408, the account user interface is presented to the customer. The method proceeds from step 408 as described above. Although the present invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A media distribution device for selectively delivering media content to a media presentation device, the media distribution device comprising:
a media adapter for receiving media content from a media delivery service provider;
a data adapter for receiving data from the media delivery service provider;
a local account data module containing an identification of a portion of the media content for delivery to the media presentation device; and
a local account manager operative to modify the identification of the portion of the media content for delivery to the media presentation device.

2. The media distribution device of claim 1, wherein the media content is delivered over a communication link between the media distribution device and a media delivery service provider.

3. The media distribution device of claim 1, wherein the communication link is a broadband connection.

4. The media distribution device of claim 3, wherein the broadband connection is an asymmetric digital subscriber line.

5. The media distribution device of claim 1, wherein the communication link is a satellite connection.

6. The media distribution device of claim 1, wherein the local account manager can be remotely controlled.

7. The media distribution device of claim 1, wherein the local account manager can be remotely accessed.

8. The media distribution device of claim 7, wherein the local account manager can be remotely accessed via the media adapter.

9. The media distribution device of claim 7, wherein the local account manager can be remotely accessed via the data adapter.

10. The media distribution device of claim 1, wherein the media content is delivered over a communication link between the media distribution device and a media delivery service provider and wherein the local account manager can be remotely accessed by the media delivery system.

11. The media distribution device of claim 10, wherein the local account data module can be transmitted to the media delivery service provider.

12. The media distribution device of claim 11, wherein the media delivery service provider is operative to store the local account data module.

13. The media distribution device of claim 1, wherein the local account manager can be locally accessed.

14. The media distribution device of claim 13, further comprising a user interface whereby the local account manager can be locally accessed.

15. The media distribution device of claim 14, wherein the user interface is provided via the media presentation device.

16. A media distribution system operative to selectively deliver media content to a media presentation device, the media distribution system comprising:
a media delivery service provider operative to transmit a media content stream to a media distribution device;
a customer account database for maintaining a central account associated with the media distribution device, the central account identifying a portion of the media content stream that is selected for delivery to the media presentation device;
a local account data module for maintaining a local account identifying the portion of the media content stream that is selected for delivery to the media presentation device; and
a local account manager for modifying the local account data module;
wherein the media delivery device delivers to the media presentation device portion of the media content stream identified by the local account data module.

17. The media delivery system of claim 16, wherein the local account manager is operative to autonomously transmit the local account data module to the media delivery service provider for storage as the central account.

18. The media delivery system of claim 17, wherein the local account data module is transmitted to the media delivery service provider over an asymmetric digital subscriber line.

19. The media delivery system of claim 16, wherein the media delivery service provider transmits the media stream to the media distribution device over an asymmetric digital subscriber line.

20. A method for filtering a media content stream in accordance with subscriber preferences, the method comprising the steps of:
receiving the subscriber preferences;
accessing a local stored account data module;
modifying the local stored account data module in accordance with the received subscriber preferences;
delivering a portion of the media content stream to a media presentation device, wherein the delivered portion of the media content stream is defined by the local account data module; and
transmitting the local stored account data module to a central account management center.
